(19) United States
(12) Patent Application Publication
(10) Pub. No.: US 2024/0418519 A1
(43) Pub. Date: Dec. 19, 2024

(54) TRAVELING MANAGEMENT DEVICE, TRAVELING MANAGEMENT METHOD, AND COMPUTER PROGRAM

(71) Applicant: SUMITOMO ELECTRIC INDUSTRIES, LTD., Osaka-shi, Osaka (JP)

(72) Inventors: Yu URATA, Osaka-shi (JP); Yui TSUYUMINE, Osaka-shi (JP)

(73) Assignee: SUMITOMO ELECTRIC INDUSTRIES, LTD., Osaka-shi, Osaka (JP)

(21) Appl. No.: 18/703,839

(22) PCT Filed: Nov. 4, 2022
(86) PCT No.: PCT/JP2022/041168

§ 371 Date: Apr. 23, 2024

(30) Foreign Application Priority Data
Nov. 30, 2021 (JP) 2021-194580

(51) Int. Cl. G01C 21/34; G01C 21/36

(52) U.S. Cl. CPC G01C 21/343; G01C 21/367; G01C 21/3697

(57) ABSTRACT

A travel management device includes: a travel plan information acquisition unit that acquires travel plan information pertaining to travel of a vehicle to a plurality of locations; and a display data generation unit that generates display data for use in displaying by a display device. The display data includes a superimposition information set to be superimposed on positions on a map respectively corresponding to the locations on the basis of the travel plan information. The superimposition information set includes information having a display mode in which distinction can be made between a location that the vehicle is scheduled to visit once and a location that the vehicle is scheduled to visit a plurality times.

### TECHNICAL FIELD

The present disclosure relates to a traveling management device, a traveling management method, and a computer program. This application claims priority based on Japanese Patent Application No. 2021-194580 filed on Nov. 30, 2021, and the entire contents of the Japanese patent application are incorporated herein by reference.

### BACKGROUND ART

The collection and delivery service management device described in PTL 1 displays a collection and delivery route and a current position of a collection and delivery worker on a map based on a collection and delivery plan and the current position of the collection and delivery worker.

### CITATION LIST

### Patent Literature

PTL 1: Japanese Unexamined Patent Application Publication No. 2021-026445

### SUMMARY OF THE INVENTION

A traveling management device according to an aspect of the present disclosure includes, a traveling plan information acquiring unit configured to acquire traveling plan information indicating a traveling plan of a vehicle to a plurality of points, and a display data generating unit configured to generate display data to be used for display on a display device. The display data includes a superimposing information set to be superimposed, based on the traveling plan information, at positions corresponding to the respective points on a map, and the superimposing information set includes information having a display form by which it is possible to identify a point for which a number of scheduled visits of the vehicle is one and a point for which the number of scheduled visits of the vehicle is plural.

A traveling management method according to another aspect of the present disclosure includes, acquiring traveling plan information indicating a traveling plan of a vehicle to a plurality of points, and generating display data to be used for display on a display device. The display data includes a superimposing information set to be superimposed, based on the traveling plan information, at positions corresponding to the respective points on a map, and the superimposing information set includes information having a display form by which it is possible to identify a point for which a number of scheduled visits of the vehicle is one and a point for which the number of scheduled visits of the vehicle is plural.

A computer program according to another aspect of the present disclosure is a computer program for causing a computer to function as, a traveling plan information acquiring unit configured to acquire traveling plan information indicating a traveling plan of a vehicle to a plurality of points; and a display data generating unit configured to generate display data to be used for display on a display device. The display data includes a superimposing information set to be superimposed, based on the traveling plan information, at positions corresponding to the respective points on a map, and the superimposing information set includes information having a display form by which it is possible to identify a point for which a number of scheduled visits of the vehicle is one and a point for which the number of scheduled visits of the vehicle is plural.

### BRIEF DESCRIPTION OF THE DRAWINGS

FIG. 1 is a figure showing the overall configuration of a traveling management system according to embodiment 1 of the present disclosure.

FIG. 2 is a figure showing an example of the configuration of the traveling management device according to embodiment 1 of the present disclosure.

FIG. 3 is a figure showing an example of traveling plan information.

FIG. 4 is a figure showing points and a traveling route of vehicle indicated by traveling plan information on a map.

FIG. 5 is a figure showing an example of a display displayed on the manager terminal or the driver terminal.

FIG. 6 is a figure showing an example of a display displayed on the parcel owner terminal of the sender.

FIG. 7 is a figure showing an example of a display displayed on the parcel owner terminal of the recipient.

FIG. 8 is a flowchart showing the procedure of the travel management process of the vehicle executed by the traveling management device.

FIG. 9 is a figure showing an example of a display displayed on the manager terminal or the driver terminal.

FIG. 10 is a figure showing an example of a display displayed on the parcel owner terminal of the recipient.

FIG. 11 is a figure showing an example of a display displayed on the manager terminal or the driver terminal.

FIG. 12 is a figure showing an example of a display displayed on the parcel owner terminal of the sender.

FIG. 13 is a figure showing an example of a display displayed on the parcel owner terminal of the recipient.

FIG. 14 is a figure showing an example of a display displayed on the manager terminal or the driver terminal.

FIG. 15 is a figure showing an example of a display displayed on the parcel owner terminal of the sender.

FIG. 16 is a figure showing an example of a display displayed on the parcel owner terminal of the recipient.

FIG. 17 is a figure showing an example of a display displayed on the manager terminal or the driver terminal.

FIG. 18 is a figure showing an example of a display displayed on the parcel owner terminal of the sender.

FIG. 19 is a figure showing an example of a display displayed on the parcel owner terminal of the recipient.

### DETAILED DESCRIPTION

### Problems to be Solved by Present Disclosure

A system for visualizing the delivery status of parcels by the vehicle based on the positional information of the vehicle and the delivery plan of parcels has been developed, for the worker to know the movement of a parcel or a vehicle in a series of delivery tasks from the collecting packages from the delivery source to delivering them to the delivery destination by vehicle.

The collection and delivery service management device described in PTL 1 displays a collection and delivery route and a current position of a collection and delivery worker on a map based on a collection and delivery plan and the current position of the collection and delivery worker. In this collection and delivery service management device, points of collection or delivery of parcels are indicated by icons, and the points are connected by lines to indicate a collection and delivery route. The icon indicates the order of visiting. Thus, the user who sees the display on which the map is displayed can understand the order of visiting each point. However, in PTL 1, a case where the worker visits the same point a plurality of times for collection or delivery is not assumed. Therefore, for example, when the user visits the same point as the second and sixth destination, only one order of visiting may be displayed and the other orders of visiting may not be displayed. As described above, the conventional collection and delivery service management device has a problem that the number of visits to each point cannot be intuitively known.

This problem is not limited to physical distribution, but also occurs in transportation of a person such as ride sharing.

The present disclosure has been made in view of the above problem, and an object of the present disclosure is to provide a traveling management device, a traveling management method, and a computer program that enable the number of scheduled visits of each point to be intuitively known.

### Advantageous Effects of Present Disclosure

According to the present disclosure, the number of scheduled visits of each point can be intuitively known.

### Overview of Embodiments of Present Disclosure

First, an overview of embodiments of the present disclosure will be listed and described.
(1) A traveling management device according to an embodiment of the present disclosure includes, a traveling plan information acquiring unit configured to acquire traveling plan information indicating a traveling plan of a vehicle to a plurality of points, and a display data generating unit configured to generate display data to be used for display on a display device. The display data includes a superimposing information set to be superimposed, based on the traveling plan information, at positions corresponding to the respective points on a map, and the superimposing information set includes information having a display form by which it is possible to identify a point for which a number of scheduled visits of the vehicle is one and a point for which the number of scheduled visits of the vehicle is plural.

According to this configuration, it can be identified by the superimposing information set that a point for which a number of scheduled visits of the vehicle is one and a point for which the number of scheduled visits of the vehicle is plural. The superimposing information set can be displayed at a position corresponding to each point. This allows a user to intuitively know the number of scheduled visits to each point.
(2) The above-described traveling management device may further include, a traveling record information acquiring unit configured to acquire traveling record information indicating a traveling record of the vehicle to the plurality of points. The display data generating unit may configured to add, based on the traveling record information, visit records at the respective points to the display data.

According to this configuration, the visit record to each point can be displayed. Thus, the user can know the visit record to each point.
(3) The superimposing information set may include, a figure set in which figures, a number of which corresponds to the number of scheduled visits, are arranged.

According to this configuration, the user can intuitively know the number of scheduled visits to each point, and can know the number of scheduled visits to each point in detail by checking the number of figures.
(4) The superimposing information set may include, a figure set in which figures, a number of which corresponds to the number of scheduled visits, are arranged, and the display data generating unit is configured to update the display data by varying, based on a number of visits completed, a display form of the figures included in the figure set for each of the points.

According to this configuration, the user can intuitively know the number of scheduled visits to each point, and can know the number of scheduled visits to each point in detail by checking the number of figures. Further, by checking the number of figures in each display form, the number of visits completed and the number of visits not made yet for each point can be known.
(5) The superimposing information set may include, a figure set in which figures, a number of which corresponds to a number of visits not made yet out of the number of scheduled visits, are arranged.

According to this configuration, the user can intuitively know the number of visits not made yet to each point, and can know the number of visits not made yet to each point in detail by confirming the number of figures.
(6) The traveling plan information may include, a scheduled arrival time of the vehicle at each of the points, and the display data generating unit is configured to add, to the display data, the scheduled arrival time at each of the points corresponding to the figure set, in association with the figure set.

According to this configuration, the scheduled arrival time at the point corresponding to the figure set is displayed in association with the figure set. Therefore, when the vehicle visits the same point a plurality of times, the user can check the scheduled arrival time of the plurality of times at the point.
(7) The superimposing information set may include, a figure indicating the number of scheduled visits.

According to this configuration, the user can know the number of scheduled visits to the point by viewing the figure.
(8) The superimposing information set may include, a figure having a display form corresponding to the number of scheduled visits.

According to this configuration, the user can intuitively know the number of scheduled visits from the display form of the figure. For example, when the size of the figure is larger as the number of scheduled visits is larger, the number of scheduled visits can be intuitively known from the size of the figure.
(9) The traveling plan information may include, a scheduled arrival time of the vehicle at each of the points, and the display data generating unit may configured to add, to the display data, the scheduled arrival time at each of the points corresponding to the figure, in association with the figure.

According to this configuration, the scheduled arrival time at the point corresponding to the figure is displayed in association with the figure. Therefore, when the vehicle visits the same point a plurality of times, the user can check the scheduled arrival time of the plurality of times at the point.
(10) The traveling plan information may include, a scheduled arrival time of the vehicle at each of the points, and the superimposing information set includes a figure indicating the scheduled arrival time in association with a time axis.

According to this configuration, a figure indicating the scheduled arrival time in association with the time axis is displayed at a position corresponding to the point. Therefore, the user can know the scheduled arrival time and the number of scheduled visits of each point.
(11) The traveling plan information may include, a scheduled arrival time of the vehicle for each of the points, the superimposing information set includes a figure indicating the scheduled arrival time in association with a time axis, and the display data generating unit may configured to add, for each of the points, to the display data, a number of visits completed of the vehicle at the point in association with the superimposing information set.

According to this configuration, a figure indicating the scheduled arrival time in association with the time axis is displayed at a position corresponding to the point. Therefore, the user can know the scheduled arrival time and the number of scheduled visits of each point. Further, the number of visits completed is displayed in association with the superimposing information set, and thus the user can know the number of visits completed of each point.
(12) The display data to be used for display on the display device used by a parcel owner of a parcel conveyed in the vehicle may include the superimposing information set having a display form corresponding to a number of scheduled visits at a point of a destination of the parcel relating to the parcel owner.

According to this configuration, the parcel owner can intuitively know the number of scheduled visits of the parcel related to the parcel of the parcel owner itself. Further, according to this configuration, it is possible to protect the privacy of a user other than the parcel owner.
(13) A traveling management method according to another embodiment of the present disclosure includes, acquiring traveling plan information indicating a traveling plan of a vehicle to a plurality of points, and generating display data to be used for display on a display device. The display data includes a superimposing information set to be superimposed, based on the traveling plan information, at positions corresponding to the respective points on a map, and the superimposing information set includes information having a display form by which it is possible to identify a point for which a number of scheduled visits of the vehicle is one and a point for which the number of scheduled visits of the vehicle is plural.

This configuration includes characteristic processing in the above-described traveling management device as steps. According to this configuration, the same operation and effect as the above-described traveling management device can be achieved.
(14) A computer program according to another embodiment of the present disclosure is a computer program for causing a computer to function as, a traveling plan information acquiring unit configured to acquire traveling plan information indicating a traveling plan of a vehicle to a plurality of points; and a display data generating unit configured to generate display data to be used for display on a display device. The display data includes a superimposing information set to be superimposed, based on the traveling plan information, at positions corresponding to the respective points on a map, and the superimposing information set includes information having a display form by which it is possible to identify a point for which a number of scheduled visits of the vehicle is one and a point for which the number of scheduled visits of the vehicle is plural.

According to this configuration, the computer can be caused to function as the above-described traveling management device. Therefore, the same operation and effect as the above-described traveling management device can be achieved.

The present disclosure can also be realized as a computer program for causing a computer to execute the characteristic steps included in the traveling management method. The present disclosure can be realized as a semiconductor integrated circuit that realizes a part or all of the traveling management device, or can be realized as a traveling management system including the traveling management device.

### Details of Embodiments of Present Disclosure

Hereinafter, embodiments of the present disclosure will be described with reference to the drawings. The embodiments described below each show a specific example of the present disclosure. The numerical values, shapes, materials, configuration elements, the arrangement and connection of the configuration elements, steps, the order of the steps, and the like shown in the following embodiments are mere examples, and do not limit the present disclosure. Among the configuration elements in the following embodiments, configuration elements not described in the independent claims are configuration elements that can be arbitrarily added. Each drawing is a schematic view and is not necessarily illustrated in detail.

The same configuration elements are denoted by the same reference numerals. Since the functions and terms of these are the same, the description thereof will be omitted as appropriate.

### Embodiment 1

In embodiment 1 of the present disclosure, a traveling management system that manages traveling of a vehicle is described, which is intended for joint delivery in which a plurality of parcels requested to be delivered from a plurality of senders are loaded in one vehicle and delivered to destinations of recipients of the parcels.

In the case of the joint delivery, the parcel collected from the sender, and the parcel is delivered or transferred to the recipient, and the traveling management system manages whether the collection, delivery, or transfer is performed without delay.

### [Overall Configuration of Traveling Management System]

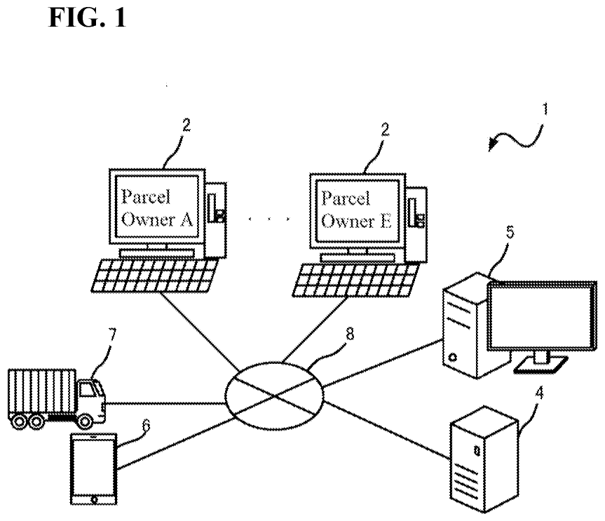

FIG. 1 is a figure showing the overall configuration of a traveling management system according to embodiment 1 of the present disclosure.

Referring to FIG. 1, a traveling management system 1 is a system for managing traveling of a vehicle that jointly delivers the parcel, and includes a plurality of parcel owner terminals 2, a traveling management device 4, a manager terminal 5, a driver terminal 6, and a vehicle 7.

Vehicle 7 is a delivery vehicle such as a truck or a van that is loaded with parcels for a plurality of recipients and delivers the parcels to each recipient. Vehicle 7 includes a position specifying unit that specifies the position of vehicle 7. The position specifying unit specifies the position of vehicle 7 by using satellite navigation. For example, the position specifying unit specifies the position of vehicle 7 based on radio waves received from a plurality of global positioning system (GPS) satellites. The position of vehicle 7 can be specified by, for example, latitude and longitude. In the satellite navigation, a satellite positioning system (GNSS: Global Navigation Satellite System) such as GPS is used, but is not limited to GPS.

Parcel owner terminal 2 is a terminal device used by a sender or a recipient.

Manager terminal 5 is a terminal device used by an operation manager of vehicle 7 or a manager of a parcel delivered by vehicle 7 (hereinafter, referred to as a “manager”).

Driver terminal 6 is a terminal device used by the driver of vehicle 7, and is, for example, a smartphone carried by the driver of vehicle 7 or a fellow passenger of vehicle 7. It is noted that, driver terminal 6 may be an in-vehicle terminal device installed in vehicle 7 in advance.

Traveling management device 4 performs control for displaying the traveling state of vehicle 7 on the display of parcel owner terminal 2, the display of manager terminal 5, and the display of driver terminal 6.

Parcel owner terminal 2, traveling management device 4, manager terminal 5, driver terminal 6, and vehicle 7 are connected to a network 8 such as the Internet in a wired or wireless manner, and can transmit and receive data to and from each other.

### [Configuration of Traveling Management Device 4]

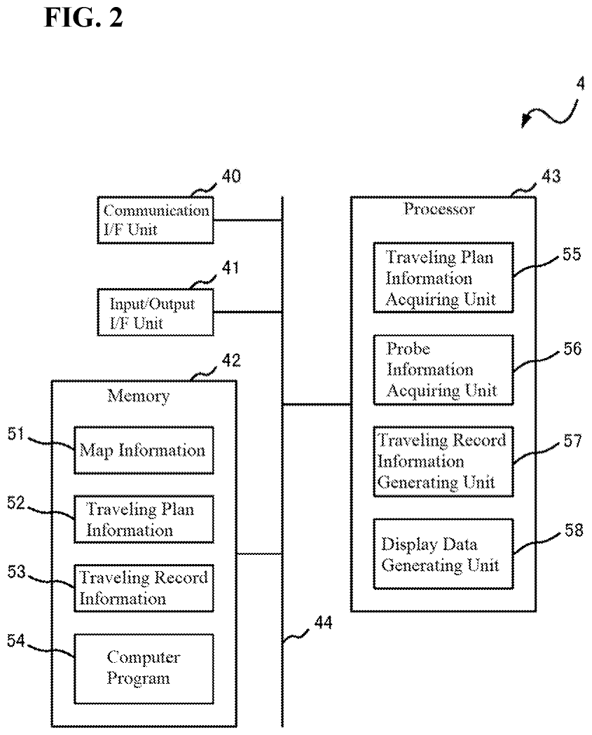

FIG. 2 is a figure showing an example of the configuration of traveling management device 4 according to embodiment 1 of the present disclosure.

Traveling management device 4 is configured by a computer, and includes a communication I/F (interface) unit 40, an input/output I/F unit 41, a memory 42, and a processor 43 that are connected to each other via a bus 44.

Communication I/F unit 40 includes a transmission module for performing wired or wireless transmission with an external device.

Input/output I/F unit 41 includes an interface for connecting an input device such as a keyboard and a mouse and an output device such as a display device to traveling management device 4.

Memory 42 is configured by, for example, a volatile memory device such as a Static RAM (SRAM) or a Dynamic RAM (DRAM), a nonvolatile memory device such as a flash memory or an Electrically Erasable Programmable Read Only Memory (EEPROM), or a magnetic storage unit such as a hard disk.

Memory 42 stores a computer program 54 to be executed by processor 43. Memory 42 stores a map information 51, a traveling plan information 52, and a traveling record information 53 used when computer program 54 is executed. Map information 51 is information indicating a map on the route on which vehicle 7 travels. Traveling plan information 52 is information indicating a traveling plan of vehicle 7. Traveling record information 53 is information indicating the traveling record of vehicle 7. Further, memory 42 also stores data generated during execution of computer program 54.

Processor 43 is configured by, for example, a Central Processing Unit (CPU). Processor 43 includes a traveling plan information acquiring unit 55, a probe information acquiring unit 56, a traveling record information generating unit 57, and a display data generating unit 58 as functional processing units realized by executing computer program 54 stored in memory 42.

Traveling plan information acquiring unit 55 acquires traveling plan information 52 by reading traveling plan information 52 from memory 42. When traveling plan information 52 is stored in an external device, traveling plan information acquiring unit 55 may receive traveling plan information 52 from the external device via communication I/F unit 40.

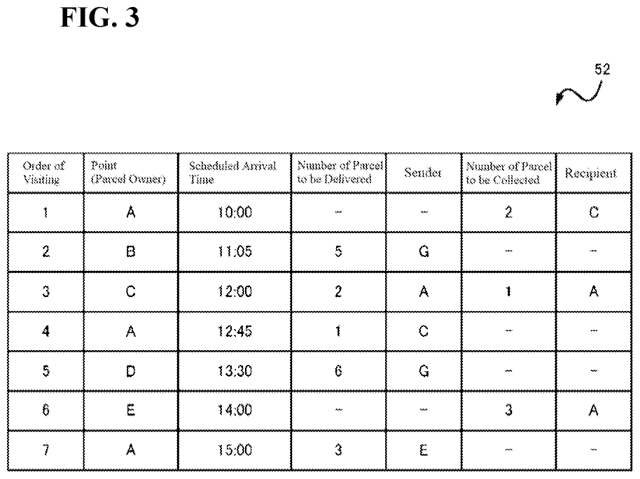

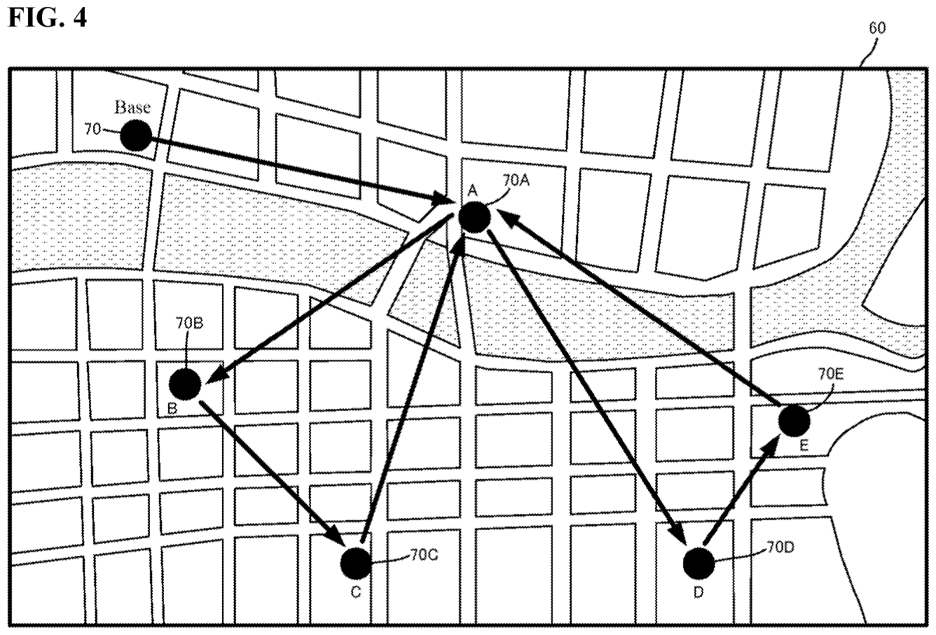

FIG. 3 is a figure showing an example of traveling plan information 52. Vehicle 7 performs delivery of the parcel in accordance with traveling plan information 52. FIG. 4 is a figure showing points and the traveling route of vehicle 7 indicated in traveling plan information 52 on a map 60. In FIG. 4, the base is indicated by a circle 70, the points A to E are indicated by a circle 70A to a circle 70E, respectively, and the moving direction of vehicle 7 from the base to the point and the moving direction of vehicle 7 from the point to another point are indicated by arrows. The “base” indicates a location of a delivery base of the parcel, and the “point” indicates a location where the parcel is collected or delivered. The operator (driver) loads the parcel into vehicle 7 at the base, and then starts delivery of the parcel by vehicle 7. In FIGS. 3 and 4, vehicle 7 is scheduled to visit the points in the order of the point A, the point B, the point C, the point A, the point D, the point E, and the point A from the base.

Referring to FIG. 3, traveling plan information 52 includes information of order of visiting, point (parcel owner), scheduled arrival time, number of parcel to be delivered, sender, number of parcel to be collected, and recipient.

The “order of visiting” indicates the order of visiting each point. Vehicle 7 visits each point in the order of the number of the order of visiting.

The “point (parcel owner)” represents a term for identifying a location visited by vehicle 7. Here, the term for identifying the parcel owner in each point is the same as the term of the point. For example, the term of the parcel owner at point A is “A” (parcel owner A). The term of the point and the term of the parcel owner may be different.

The “scheduled arrival time” indicates the scheduled arrival time of vehicle 7 at each point. The “number of parcel to be delivered” indicates the number of parcels delivered to each point. The “sender” indicates a term for identifying the sender of the parcel delivered to each point. The “number of parcel to be collected” indicates the number of parcels to be collected from each point. The “recipient” indicates a term for identifying a recipient that is a destination of a parcel picked up from each point.

The following delivery plan is shown in traveling plan information 52 shown in FIG. 3. Vehicle 7 arrives at “point A” with the order of visiting “No. 1” at “10:00”, and is scheduled to collect “2” parcels from “parcel owner A” for delivery to “recipient C”. Vehicle 7 arrives at “point B” with the order of visiting “No. 2” at “11:05”, and is scheduled to deliver “5” parcels requested from “sender G” to “parcel owner B”. Vehicle 7 arrives at “point C” with the order of visiting “No. 3” at “12:00”, and is scheduled to deliver “2” parcels requested by “sender A” to “parcel owner C” and collect “1” parcel to be delivered to “recipient A” from “parcel owner C”. Vehicle 7 arrives at “point A” with the order of visiting “No. 4” at “12:45”, and is scheduled to deliver “1” parcel requested by “sender C” to “parcel owner A”. Vehicle 7 arrives at “point D” with the order of visiting “No. 5” at “13:30”, and is scheduled to deliver “6” parcels requested from “sender G” to “parcel owner D”. Vehicle 7 arrives at “point E” with the order of visiting “No. 6” at “14:00”, and is scheduled to collect “3” parcels to be delivered to “recipient A” from “parcel owner E”. Vehicle 7 arrives at “point A” with the order of visiting “No. 7” at “15:00”, and is scheduled to deliver “3” parcels requested from “sender E” to “parcel owner A”. The parcel of sender G in with the order of visiting “No. 2” and “No. 5” is scheduled to be loaded into vehicle 7 at the base.

As described above with reference to FIGS. 3 and 4, vehicle 7 is scheduled to visit the point A three times and visit the points B to E one time each.

Referring again to FIG. 2, probe information acquiring unit 56 acquires probe information of vehicle 7 by receiving the probe information indicating the position of vehicle 7 and the time at which vehicle 7 is present at the position from vehicle 7 via communication I/F unit 40. Probe information acquiring unit 56 may receive the probe information of vehicle 7 from another device instead of directly receiving the probe information from vehicle 7.

Traveling record information generating unit 57 generates traveling record information 53 indicating the traveling record of vehicle 7 based on the traveling plan information acquired by traveling plan information acquiring unit 55 and the probe information acquired by probe information acquiring unit 56. That is, traveling record information generating unit 57 determines the number of visits completed (the number of visit records) to each point indicated in the traveling plan information based on the probe information.

For example, the latitude and longitude of each point are determined in advance. Further, for example, a circular area around each point is set as the geofence.

Traveling record information generating unit 57 determines, for each point, the time at which vehicle 7 moves from the outside of the geofence of the point to the inside of the geofence and the traveling speed first becomes zero in the geofence, as the actual arrival time at the point. When vehicle 7 moves from the inside of the geofence to the outside of the geofence, traveling record information generating unit 57 determines that the time at which the traveling speed finally becomes zero in the geofence is the actual departure time from the point. The traveling speed is calculated based on the probe information. When the probe information includes information on the traveling speed, the actual arrival time and the actual departure time may be determined using the information. The shape of the geofence is not limited to a circle, and may be other shapes such as an ellipse and a polygon.

Traveling record information generating unit 57 determines the number of visits completed to each point based on the determined actual arrival time at each point and actual departure time for each point. For example, traveling record information generating unit 57 may determine the number of actual arrival times determined for each point as the number of visits completed to the point. Further, when the actual arrival time at the second point to be visited after the first point is after the actual departure time from an arbitrary first point indicated in traveling plan information 52, traveling record information generating unit 57 may determine that vehicle 7 has visited the second point and may determine the number of visits completed to the second point.

Traveling record information generating unit 57 stores traveling record information 53 indicating the determined number of visits completed to each point in memory 42.

Display data generating unit 58 generates display data to be displayed on the display devices of parcel owner terminal 2, manager terminal 5, and driver terminal 6, and transmits the generated display data to each terminal via communication I/F unit 40. Each terminal receives the display data, generates a display based on the display data, and causes the display device of the terminal to display the generated display.

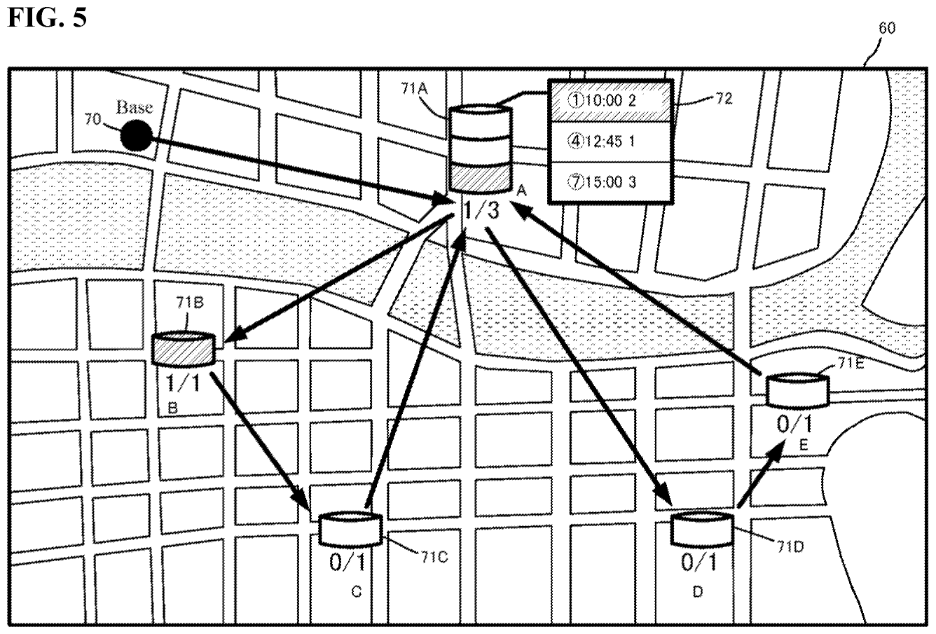

FIG. 5 is a figure showing an example of a display displayed on manager terminal 5 or driver terminal 6. In this case, the visit to the point B of which the order of visiting is “No. 2” in traveling plan information 52 is completed.

The display includes map 60, circle 70 is arranged at a position corresponding to the base on map 60, and a figure set 71A to a figure set 71E which are the superimposing information sets are arranged in a superimposed manner at positions corresponding to the point A to the point E on map 60. The superimposing information set is information that has a display form. The display form may identify a point for which a number of scheduled visits of vehicle 7 is one and a point for which the number of scheduled visits of vehicle 7 is plural. Hereinafter, figure sets 71A to 71E are also referred to as figure sets 71 when they are not distinguished from each other. The moving direction of vehicle 7 from the base to the point and the moving direction of vehicle 7 from the point to another point are indicated by arrows.

Figure set 71 will be described. Figure set 71 is an arrangement including one or more column diagrams in the vertical direction, and the number of column diagrams indicates the number of scheduled visits of vehicle 7 to the point where figure set 71 is arranged. For example, figure set 71A is an arrangement including three column diagrams in the vertical direction. In this case, the number of scheduled visits of vehicle 7 to point A is three. Each of figure sets 71B to 71E includes one column diagram. In this case, the number of scheduled visits of vehicle 7 from point B to point E is one in each.

The column diagram has two types of display forms. Here, the number of hatched column diagrams (hereinafter referred to as “hatched figure”) indicates the number of visits completed to the point, and the number of unhatched column diagram (hereinafter referred to as “unhatched figure”) indicates the number of visits not made yet. The number of visits not made yet can be calculated by subtracting the number of visits completed from the number of scheduled visits. Here, figure set 71A includes one hatched figure and two unhatched figures. In this case, the number of visits completed to the point A is one, and the number of visits not made yet is two. It is noted that, each column diagram corresponds to one visit, and column diagrams for earlier order of visiting are arranged at lower positions. That is, in figure set 71A, the column diagrams corresponding to the visiting orders “No. 1”, “No. 4”, and “No. 7” in order from the bottom are arranged.

Figure set 71B includes one hatched figure and does not include an unhatched figure. Therefore, the number of visits completed to the point B is one, and the number of visits not made yet is zero. Each of figure sets 71C to 71E includes one unhatched figure and does not include a hatched figure. Therefore, the number of visits not made yet of each of the points C to E is one, and the number of visits completed is zero. Instead of changing the hatching, the color or pattern of the column diagram may be changed to indicate whether the user has visited the site or not.

The description “n/m” is arranged at the position corresponding to each point. Here, m represents the number of scheduled visits, and n represents the number of visits completed. For example, when “⅓” is described in the point A, the number of scheduled visits and the number of visits completed to the point A are three and one, respectively. When “1/1” is described in the point B, both the number of scheduled visits and the number of visits completed to the point B are one. When “0/1” is described in each of the points C to E, the number of scheduled visits and the number of visits completed from the point C to the point E are one and zero, respectively.

When display data generating unit 58 receives a selection input of any figure set 71 from the manager or the driver, visit record data 72 showing the visit record of the point corresponding to selected figure set 71 are imparted to the display data arranged at the position corresponding to figure set 71. The selection of figure set 71 is performed by, for example, clicking or tapping figure set 71 on the display. Visit record data 72 includes the same number of subdata as the number of scheduled visits, and each subdata includes the order of visiting indicated by a circled number, the scheduled arrival time, and the parcel number (the sum of the number of parcels to be delivered and the number of parcels to be collected). Visit record data 72 displayed when figure set 71A is selected includes three subdata. In the subdata corresponding to the first order of visiting, the scheduled arrival time is 10:00, and the number of parcels is two. In the subdata, the number of parcels to be delivered and the number of parcels to be collected may be displayed separately.

The subdata corresponding to the order of visiting to the points visited and the subdata corresponding to the order of visiting to the points not visited yet are displayed in different display forms. Here, hatching is applied to the former subdata, and hatching is not applied to the latter subdata. For example, according to visit record data 72 shown in FIG. 5, the first visit to Point A has been completed, and the fourth and seventh visits to Point A have not yet been completed.

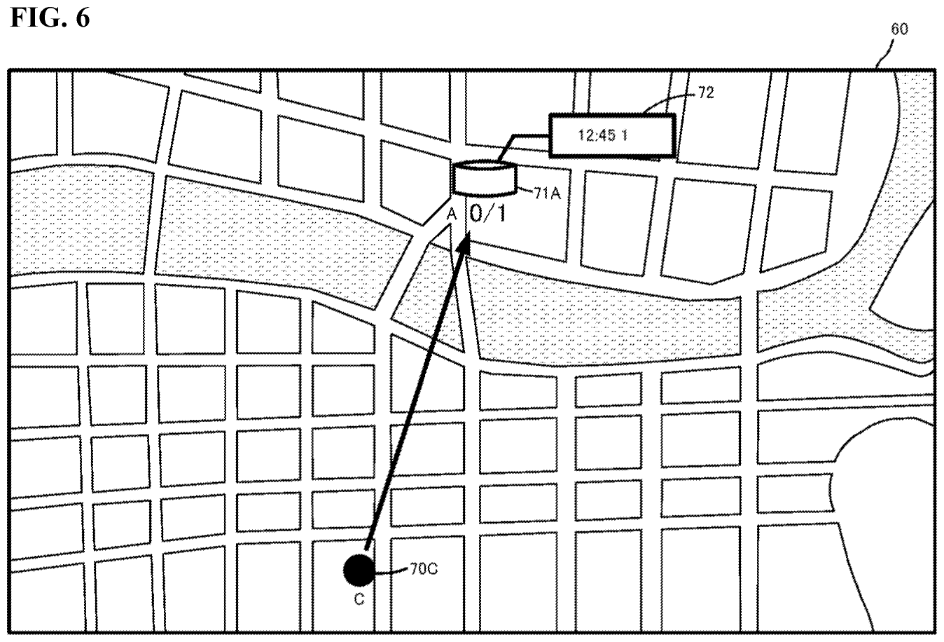

FIG. 6 is a figure showing an example of a display displayed on parcel owner terminal 2 of the sender. FIG. 6 shows an example of a display displayed on parcel owner terminal 2 of the sender C. In this case, the visit to the point B of which the visiting order is “No. 2” in traveling plan information 52 is completed.

Traveling plan information 52 shown in FIG. 3 indicates that one parcel is collected from point C (sender C) and delivered to point A. Therefore, in FIG. 6, point C is indicated by a circle 70C on map 60, and figure set 71A is displayed at point A which is the destination of the parcel of sender C. Figure set 71A indicates only information of one parcel collected from the point C, and does not indicate information collected from other points and delivered to the point A. Therefore, figure set 71A includes one column diagram. Since the parcel collected from the point C has not been ordered yet at point A, hatching is not applied to the column diagram. The point A is described as “0/1”, which indicates that the number of scheduled visits and the number of visits completed to the point A for the parcel collected from the point C are 1 and 0, respectively. When display data generating unit 58 receives the selection input of figure set 71A from the sender C, visit record data 72 corresponding to figure set 71A are imparted to the display data arranged at the position corresponding to figure set 71A. Visit record data 72 includes the same number of subdata as the number of scheduled visits (here, once), and each subdata includes a scheduled arrival time and the number of parcels to be delivered. In FIG. 6, the subdata indicates that the scheduled arrival time is 12:45 and the number of parcels to be delivered is one. Since the point A of the scheduled arrival time has been unvisited, the subdata is not hatched.

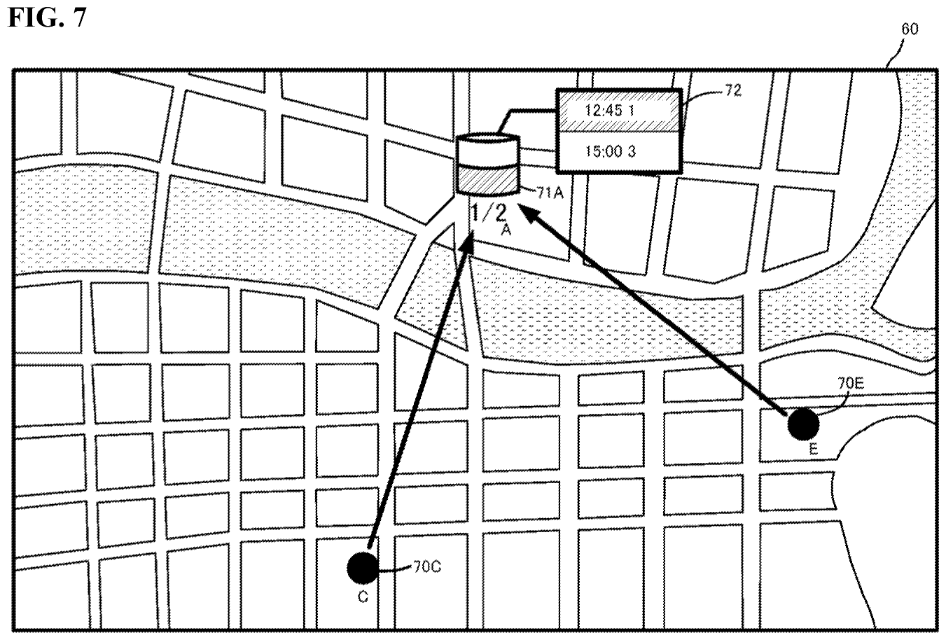

FIG. 7 is a figure showing an example of a display displayed on parcel owner terminal 2 of the recipient. FIG. 7 shows an example of a display displayed on parcel owner terminal 2 of the recipient A. In this case, the visit to the point E of which the order of visiting is “No. 6” in traveling plan information 52 is completed.

Traveling plan information 52 shown in FIG. 3 indicates that one parcel is collected from the point C and delivered to the point A and that three parcels are collected from the point E and delivered to the point A as information on parcels to be delivered to the recipient A. Therefore, in FIG. 7, the point C and the point E as the collection source are indicated by circle 70C and circle 70E, respectively, on map 60, and figure set 71A is displayed at the point A which is the destination of the parcel of the recipient A. Figure set 71A includes a column diagram corresponding to one parcel from the sender C of which the order of visiting is “No. 4” and a column diagram corresponding to three parcels from the sender E of which the order of visiting is “No. 7”. Since the parcel from the sender C has been delivered, hatching is applied to the former column diagram. Since the parcel from sender E has not been delivered, hatching is not applied to the column diagram of the latter parcel. The point A is described as “½”, which indicates that the number of scheduled visits and the number of visits completed for the parcel delivered to the point A are two and one, respectively. When display data generating unit 58 receives the selection input of figure set 71A from the recipient A, visit record data 72 corresponding to figure set 71A are imparted to the display data arranged at the position corresponding to figure set 71A. Visit record data 72 includes the same number of subdata as the number of scheduled visits (here, twice), and each subdata includes a scheduled arrival time and the number of parcels (the number of parcels to be delivered). In FIG. 7, the first subdata indicates that the scheduled arrival time is 12:45 and the number of parcels to be delivered is one, and the second subdata indicates that the scheduled arrival time is 15:00 and the number of parcels to be delivered is three. Since the point A with the scheduled arrival time of 12:45 has been visited, the first subdata is hatched. Since the point A with the scheduled arrival time of 15:00 has not been visited yet, the second subdata is not hatched.

### [Processing Procedure of Traveling Management Device]

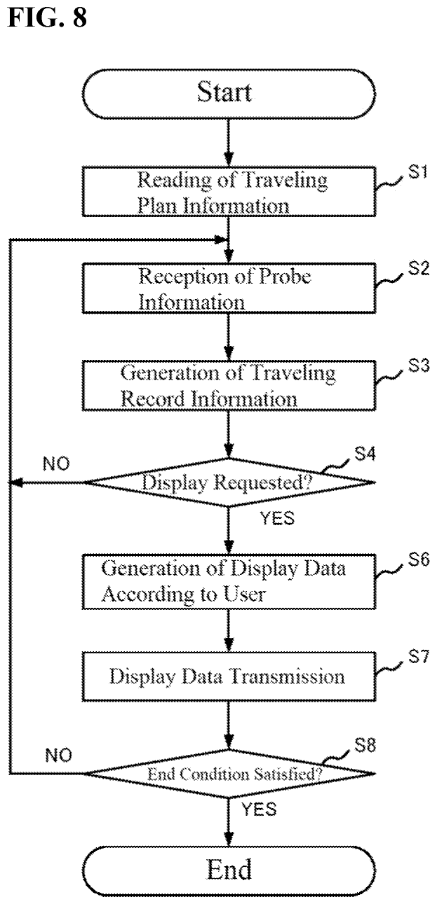

FIG. 8 is a flowchart showing the procedure of the travel management process of vehicle 7 executed by traveling management device 4.

Traveling plan information acquiring unit 55 reads traveling plan information 52 from memory 42 (step S1).

Probe information acquiring unit 56 receives probe information from vehicle 7 via communication I/F unit 40 (step S2).

Traveling record information generating unit 57 generates traveling record information 53 of vehicle 7 based on traveling plan information 52 and the probe information (step S3).

Display data generating unit 58 determines whether or not a request for display has been received from the terminal via communication I/F unit 40 (step S4). When the request of display has not been received (NO in step S4), the processes in steps S2 and S3 are repeatedly performed.

When the request of display has been received (YES in step S4), display data generating unit 58 generates display data corresponding to the user who has transmitted the request of display, based on traveling plan information 52 and traveling record information 53 (step S6). The user who has transmitted the request of display may be identified by, for example, a user ID included in the request of display or an identifier of the terminal that has transmitted the request of display. When the user is the parcel owner, it is necessary to determine whether the user is in the position of the sender or in the position of the recipient. Therefore, when the user is the parcel owner, information for distinguishing the sender or the recipient is included in the request of display.

Display data generating unit 58 generates display data for display as shown in FIG. 5 when the user is the manager or the driver of vehicle 7. Display data generating unit 58 generates display data for display as shown in FIG. 6 when the user is a sender. Display data generating unit 58 generates display data for display as shown in FIG. 7 when the user is the recipient.

As shown in FIGS. 5, 6, and 7, when the request of display includes the selection input of figure set 71, display data generating unit 58 imparts visit record data 72 corresponding to figure set 71 to the display data.

Display data generating unit 58 transmits the generated display data to the sender of the request of display via communication I/F unit 40 (step S7). The terminal generates a display based on the display data and displays the display on the display device.

Processor 43 determines whether or not the end condition is satisfied (step S8). The end condition is not limited, but for example, the reception of the end instruction of the travel management process may be set as the end condition, or the elapse of a predetermined time after vehicle 7 completes the delivery to all the points may be set as the end condition.

When the end condition is not satisfied (NO in step S8), the processing in step S2 and subsequent steps is repeatedly executed. When the end condition is satisfied (YES in step S8), traveling management device 4 terminates the travel management process.

### Effects of Embodiment 1

As described above, according to embodiment 1 of the present disclosure, figure set 71 which it is possible to identify a point for which a number of scheduled visits is one and a point for which the number of scheduled visits is plural, can be displayed at the position corresponding to each point. This allows the user to intuitively know the number of scheduled visits of each point.

The user can intuitively know the number of scheduled visits to each point from the height of figure set 71, and can know the number of scheduled visits to each point in detail by checking the number of column diagrams included in figure set 71.

The user can know the number of visits completed and the number of visits not made yet for each point by checking the number of hatched figures and the number of unhatched figures included in figure set 71.

Since visit record data 72 indicating the visit record to each point is displayed on the display device, the user can know the visit record to each point.

The scheduled arrival time is displayed in visit record data 72. When vehicle 7 visits the same point a plurality of times, the user can check a plurality of the scheduled arrival times at the point.

Parcel owner terminal 2 displays figure set 71 corresponding to the number of scheduled visits to the destination point of the parcel related to the parcel owner. This allows the parcel owner to intuitively know the number of scheduled visits to the parcel destination associated with the parcel owner's own parcel. Further, the privacy of the user other than the parcel owner can be protected.

### Modification of Embodiment 1

In the embodiment 1, whether the point has been visited or not is indicated by the display form of the column diagram included in figure set 71. In this modification, the number of column diagrams included in figure set 71 indicates the number of visits not made yet.

Display data generating unit 58 generates display data in which figure set 71 including column diagrams of the same number as the number of visits not made yet in the number of scheduled visits is arranged on map 60 for each point. Thus, the column diagram included in figure set 71 is decreased by one each time the visit to the point is completed.

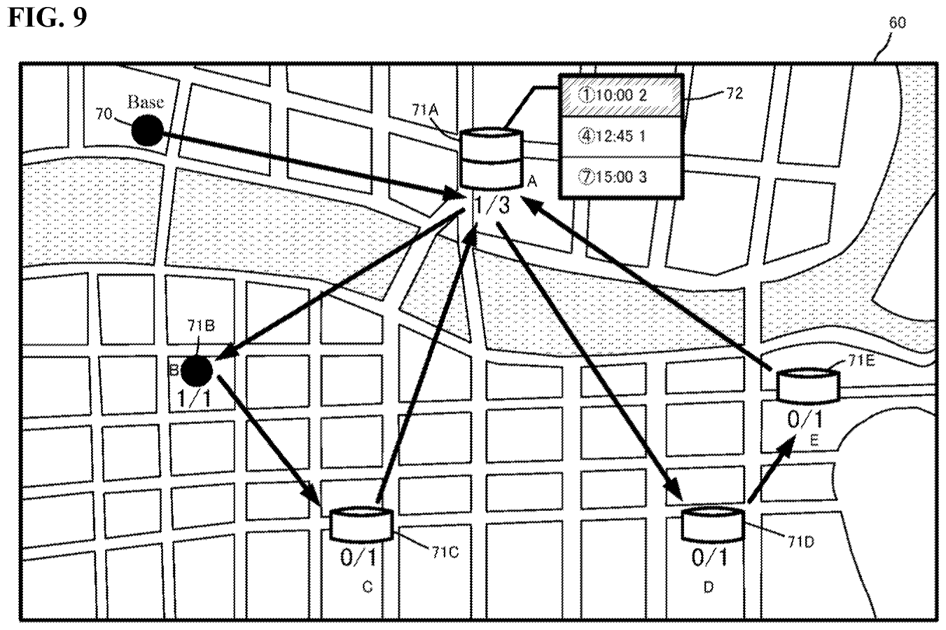

FIG. 9 is a figure showing an example of a display displayed on manager terminal 5 or driver terminal 6. FIG. 9 shows a display which is displayed instead of the display shown in FIG. 5.

Figure set 71A including two column diagrams is arranged at the point A. This indicates that the number of visits not made yet to point A (the remaining number of scheduled visits to point A) is two. A circle 70B is arranged at the point B. This indicates that the visit to the point B has been completed and the number of visits not made yet is 0. Figure sets 71C to 71E including one column diagram are arranged at the points C to E, respectively. This indicates that the number of visits not made yet from the point C to the point E is one.

Figure set 71 is changed in the same manner in the display displayed on parcel owner terminal 2 of the sender and the recipient.

When the visit to the point B having the visiting order of “No. 2” is completed in traveling plan information 52, the display displayed on parcel owner terminal 2 of the sender C is the same as that shown in FIG. 6.

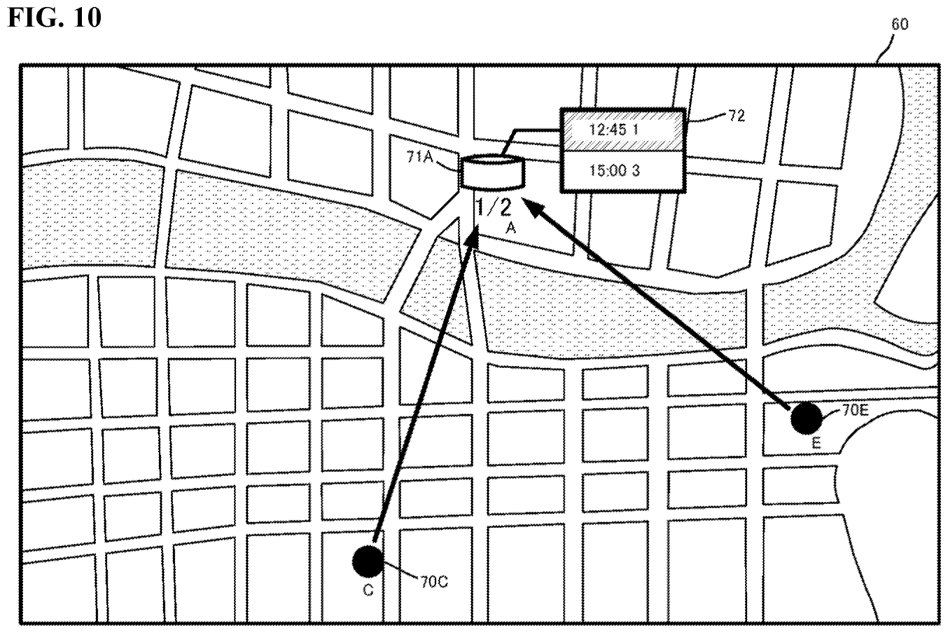

FIG. 10 is a figure showing an example of a display displayed on parcel owner terminal 2 of the recipient. FIG. 10 shows a display which is displayed instead of the display shown in FIG. 7.

Figure set 71A including one column diagram is arranged at the point A. This indicates that the number of visits not made yet (the remaining number of scheduled visits) out of the number of scheduled visits for delivery of the parcel to the recipient A is one.

According to this modification, the number of visits not made yet to each point can be intuitively known from the height of figure set 71, and the number of visits not made yet to each point can be known in detail by checking the number of column diagrams included in figure set 71.

### Embodiment 2

In the embodiment 1, figure set 71 represents the number of scheduled visits, the number of visits not made yet, or the number of visits completed to each point. In the embodiment 2, the number of scheduled visits to each point is represented by icon.

The other configuration of traveling management system 1 is the same as that shown in the embodiment 1. Therefore, the detailed description thereof will not be repeated.

The display data for generating a display to be displayed on the terminal, which will be described below, is generated by display data generating unit 58.

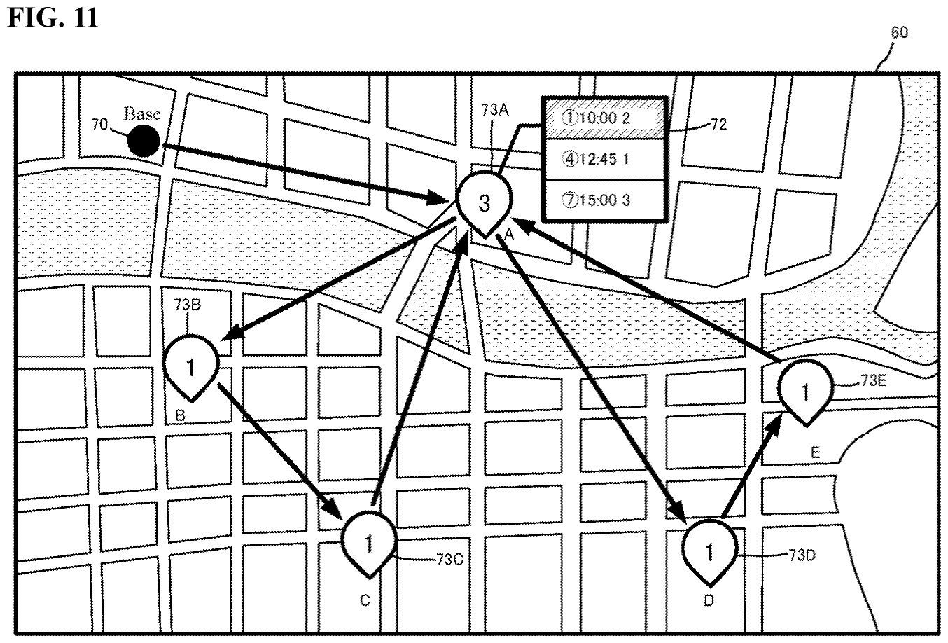

FIG. 11 is a figure showing an example of a display displayed on manager terminal 5 or driver terminal 6. FIG. 11 shows a display which is displayed instead of the display shown in FIG. 5.

The display includes map 60, circle 70 is arranged at a position corresponding to the base on map 60, and an icon 73A to an icon 73E which are the superimposing information sets are arranged at positions corresponding to the point A to the point E on map 60. Hereinafter, when icons 73A to 73E are not distinguished from each other, they are also referred to as icon 73. Other indications are the same as those shown in FIG. 5.

An icon 73 is a figure having a predetermined figure. The number of scheduled visits is described in icon 73. In FIG. 11, the number of scheduled visits “3” to the point A is described in icon 73A, and the number of scheduled visits “1” from the point B to the point E is described in icons 73B to 73E, respectively. This figure may be a figure in which the number of scheduled visits is described, and is not limited to icon 73 illustrated in FIG. 11.

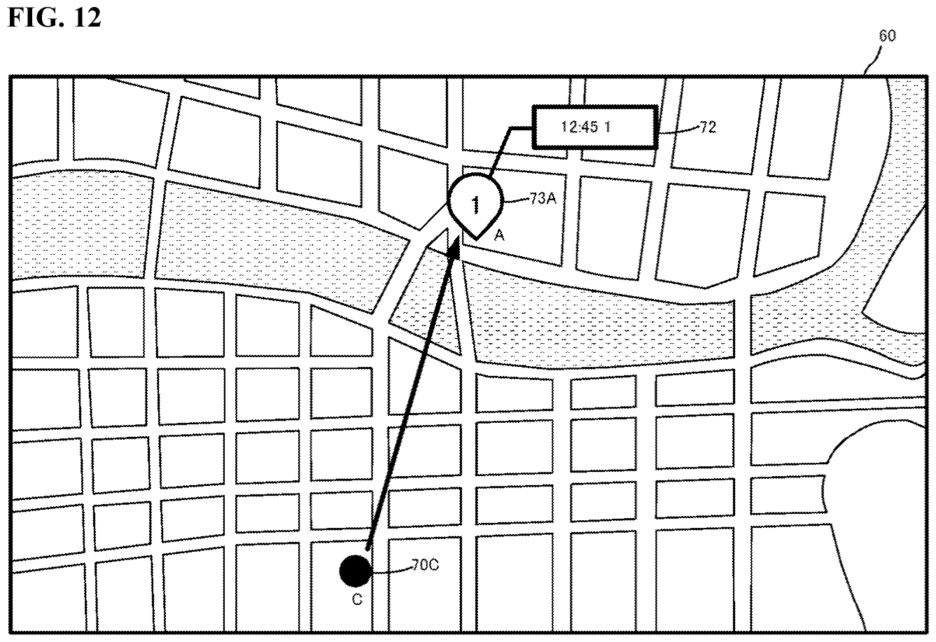

FIG. 12 is a figure showing an example of a display displayed on parcel owner terminal 2 of the sender. FIG. 12 shows a display displayed on parcel owner terminal 2 of the sender C instead of the display shown in FIG. 6.

Icon 73A describes the number of scheduled visits “1” to the point A for delivery of the parcel from the sender C.

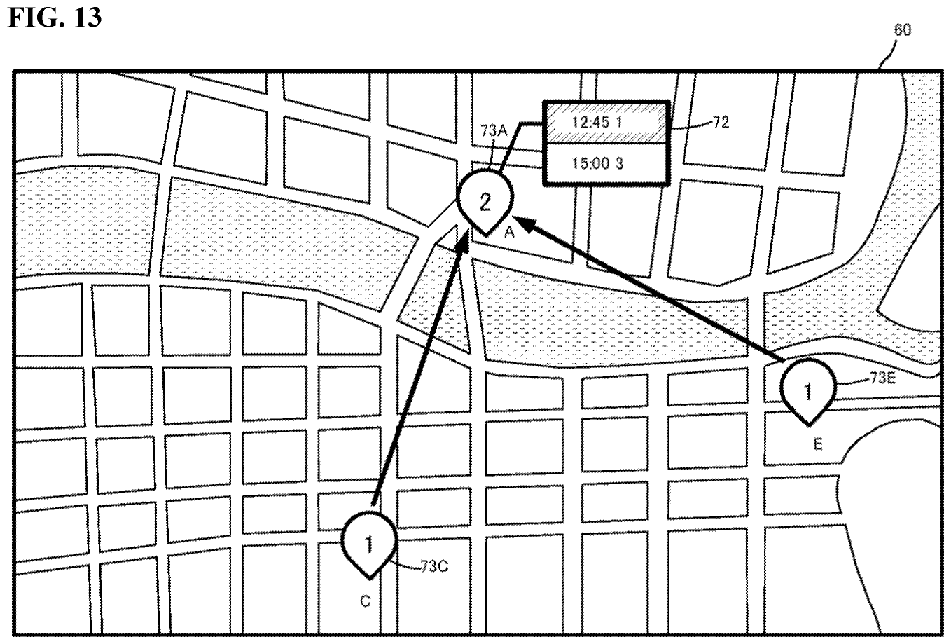

FIG. 13 is a figure showing an example of a display displayed on parcel owner terminal 2 of the recipient. FIG. 13 shows a display displayed on parcel owner terminal 2 of the recipient A instead of the display shown in FIG. 7.

Icon 73A indicates the number of scheduled visits “2” to the point A for delivery of the parcel to the recipient A. An icon 73C describes the number of scheduled visits “1” to the point C for delivery of the parcel to the recipient A. Icon 73E describes the number of scheduled visits “1” to the point E for delivery of the parcel to the recipient A.

According to the second embodiment, the user can know the number of scheduled visits of the point indicated by icon 73 by viewing icon 73 in which the number of scheduled visits is described.

The scheduled arrival time is displayed in visit record data 72. Therefore, when vehicle 7 visits the same point a plurality of times, the user can check a plurality of the scheduled arrival times at the point.

### Modification of Embodiment 2

In the second embodiment, the number of scheduled visits is described in icon 73. In this modification, the number of scheduled visits is expressed in the display form of icon 73. The display form is, for example, the size of icon 73. For example, icon 73 of a larger size may be arranged for a point having a larger number of scheduled visits.

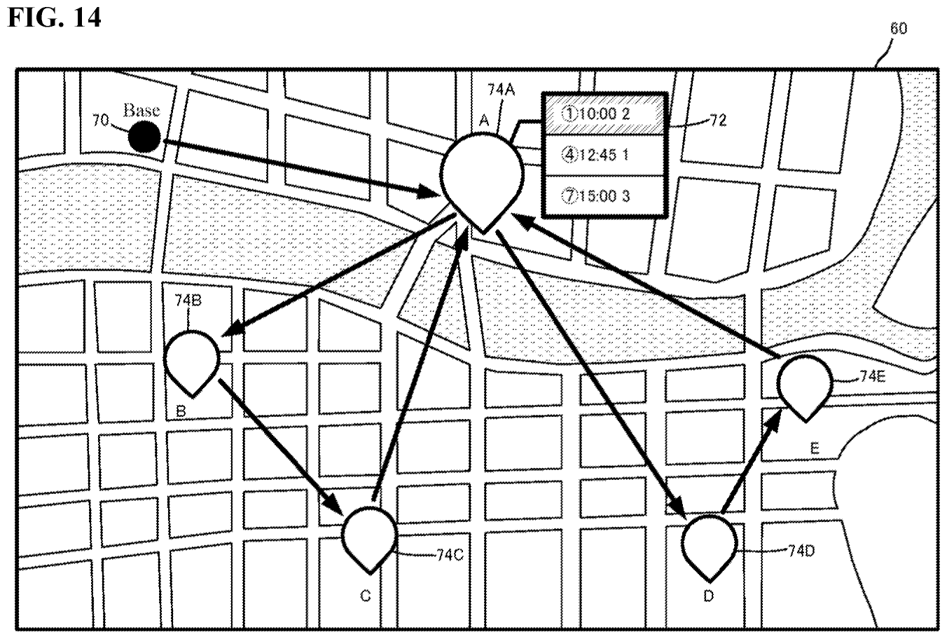

FIG. 14 is a figure showing an example of a display displayed on manager terminal 5 or driver terminal 6. FIG. 14 shows a display which is displayed instead of the display shown in FIG. 11.

The number of scheduled visits from point B to point E is one. An icon 74B to an icon 74E respectively arranged at the point B to the point E have the same size corresponding to the number of scheduled visits “1”. The number of scheduled visits to point A is three, which is greater than the number of scheduled visits from point B to point E. An icon 74A arranged at the point A has a size corresponding to the number of scheduled visits “3”, and is larger than the size of icons 74B to 74E.

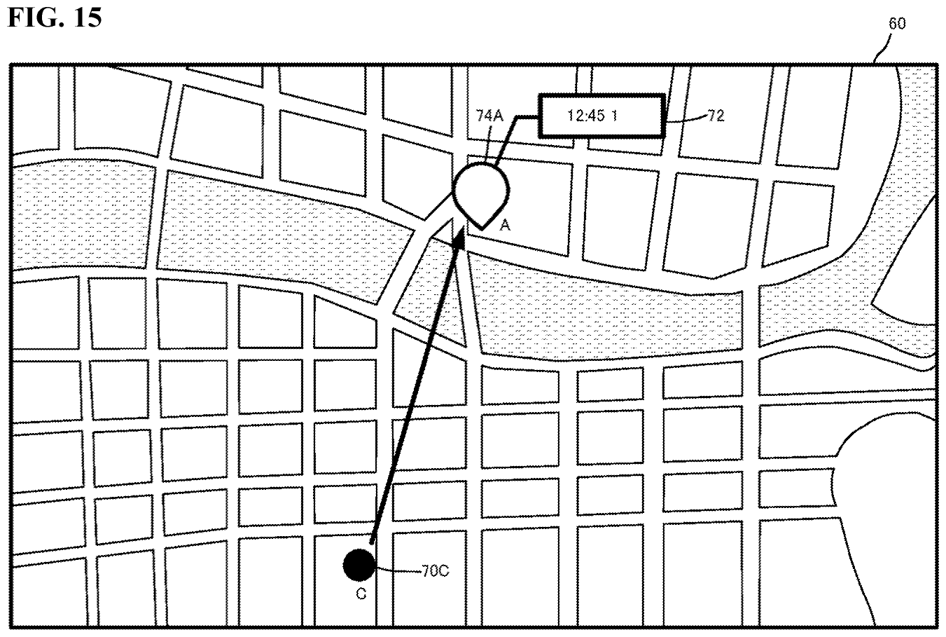

FIG. 15 is a figure showing an example of a display displayed on parcel owner terminal 2 of the sender. FIG. 15 shows a display displayed on parcel owner terminal 2 of the sender C instead of the display shown in FIG. 12.

Icon 73A has a size corresponding to the number of scheduled visits “1” to the point A for delivery of the parcel from the sender C.

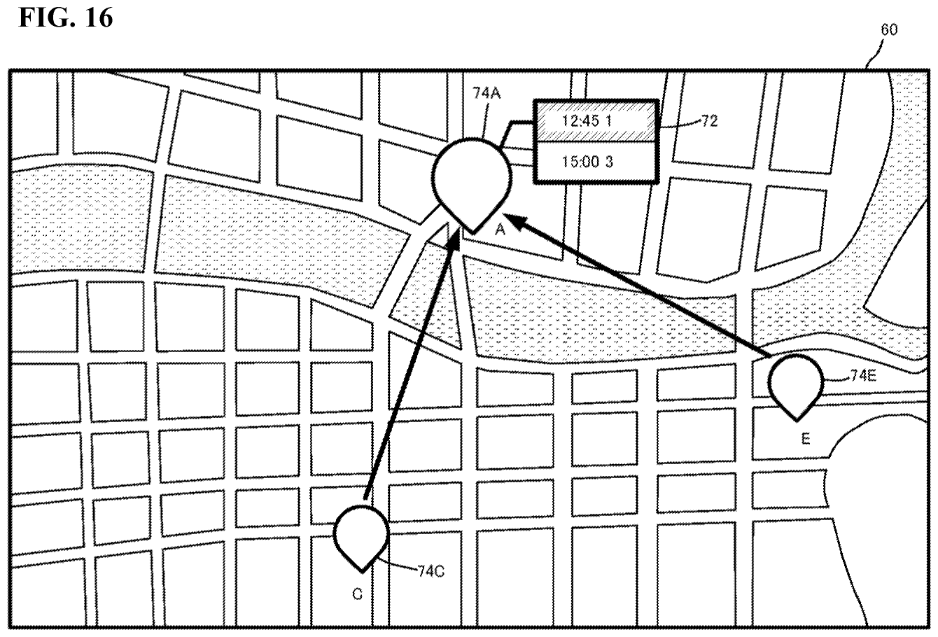

FIG. 16 is a figure showing an example of a display displayed on parcel owner terminal 2 of the recipient. FIG. 16 shows a display displayed on parcel owner terminal 2 of the recipient A instead of the display shown in FIG. 13.

The number of scheduled visits to the points C and E for delivery of the parcel to the recipient A is “1”. Icons 74C and 74E have the same size corresponding to the number of scheduled visits “1”. The number of scheduled visits to point A for delivery of the parcel to recipient A is “2”. Icon 74A has a size corresponding to the number of scheduled visits “2”, and is larger than the size of icons 74C and 74E.

According to this modification, the user can intuitively know the number of scheduled visits from the display form of an icon 74. For example, when the size of icon 74 is larger as the number of scheduled visits is larger, the number of scheduled visits can be intuitively known from the size of icon 74.

The display form is not limited to the size of icon 74. For example, the display form may be the color of icon 74. For example, the hue of the color may be closer to red as the number of scheduled visits increases, and may be closer to blue as the number of scheduled visits decreases. The saturation of the color may be increased as the number of scheduled visits increases, and the saturation of the color may be decreased as the number of scheduled visits decreases. The brightness of the color may be increased as the number of scheduled visits increases, and the brightness of the color may be decreased as the number of scheduled visits decreases.

Icon 74 may be hatched in accordance with the number of scheduled visits to indicate the number of scheduled visits.

The number of scheduled visits may be represented by the thickness of the line of the frame of icon 74. For example, the line may be made thicker as the number of scheduled visits is larger.

### Embodiment 3

In the embodiment 1, figure set 71 represents the number of scheduled visits, the number of visits not made yet, or the number of visits completed to each point.

In the third embodiment, a timetable indicating the scheduled arrival time of vehicle 7 in association with the time axis is displayed instead of figure set 71.

The other configuration of traveling management system 1 is the same as that shown in the embodiment 1. Therefore, the detailed description thereof will not be repeated.

Display data generating unit 58 generates display data for generating a display to be displayed on a terminal to be described below.

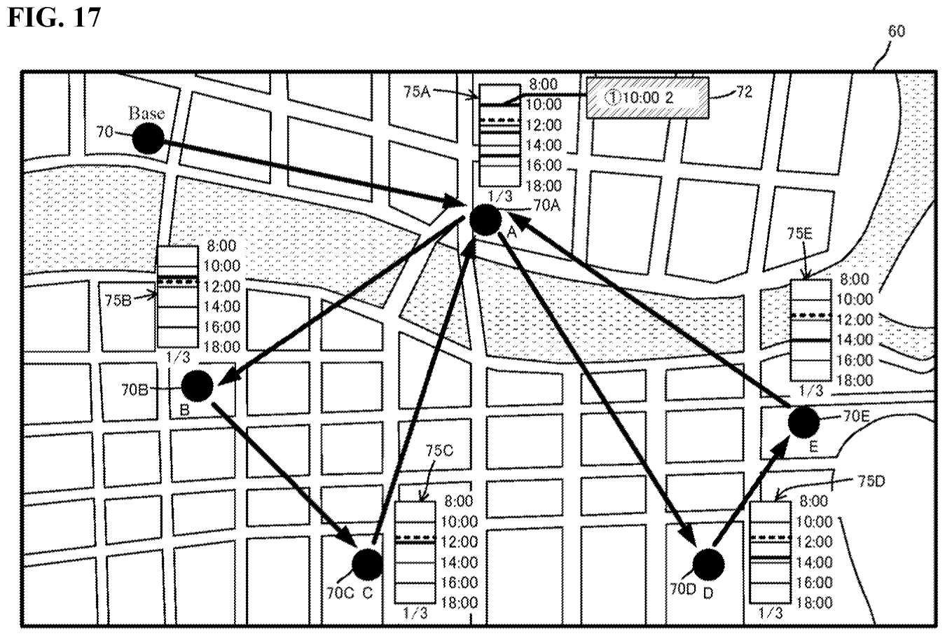

FIG. 17 is a figure showing an example of a display displayed on manager terminal 5 or driver terminal 6. FIG. 17 shows a display which is displayed instead of the display shown in FIG. 5.

The display includes map 60, circle 70 is arranged at a position corresponding to the base on map 60, and circle 70A to circle 70E and a timetable 75A to a timetable 75E which are the superimposing information sets are arranged at positions corresponding to the point A to the point E on map 60. Hereinafter, timetables 75A to 75E are also referred to as timetable 75 when they are not distinguished from each other. Other indications are the same as those shown in FIG. 5.

A timetable 75 is a figure indicating the scheduled arrival time of vehicle 7 at each point in association with the time axis. The vertical direction of timetable 75 indicates time. In timetable 75, the time has elapsed as the time is displayed at the lower position. Here, timetable 75 indicates information from 8:00 to 18:00, the scheduled arrival time is indicated by a bold line, and the current time is indicated by a dashed line. In timetable 75A, a bold line is drawn at the positions of 10:00, 12:45, and 15:00, and a dashed line is drawn at the position of 11:35. In timetable 75A, the scheduled arrival times at the point A are 10:00, 12:45, and 15:00, and the current time is 11:35. The number of scheduled visits to point A is three times because of the number of bold lines.

In a timetable 75B, the scheduled arrival time at the point B is 11:05, and the current time is 11:35. In a timetable 75C, the scheduled arrival time at the point C is 12:00, and the current time is 11:35. In a timetable 75D, the scheduled arrival time at the point D is 13:30, and the current time is 11:35. In timetable 75E, the scheduled arrival time at the point E is 14:00, and the current time is 11:35.

When display data generating unit 58 receives an input of selecting any of the bold lines from the manager or the driver, visit record data 72 indicating the visit record corresponding to the selected bold line are imparted to the display data arranged at the position corresponding to timetable 75. The selection of the bold line is performed by, for example, clicking or tapping the bold line on the display. For example, when the bold line at the position of 10:00 of timetable 75A is selected, visit record data 72 of the scheduled arrival time is displayed. Visit record data 72 includes order of visiting, scheduled arrival time, and parcel number (the sum of number of parcels to be delivered and number of parcels to be collected), which are indicated by circled numbers. In FIG. 17, visit record data 72 corresponding to the selected bold line indicates that the field of visiting is the first, the scheduled arrival time is 10:00, and the number of parcels is two. Since the visit to the point A with the scheduled arrival time of 10:00 has been completed, hatching is applied to visit record data 72, and it is indicated that the visit has been completed. Visit record data 72 corresponding to the scheduled arrival time at the point not visited yet is not hatched.

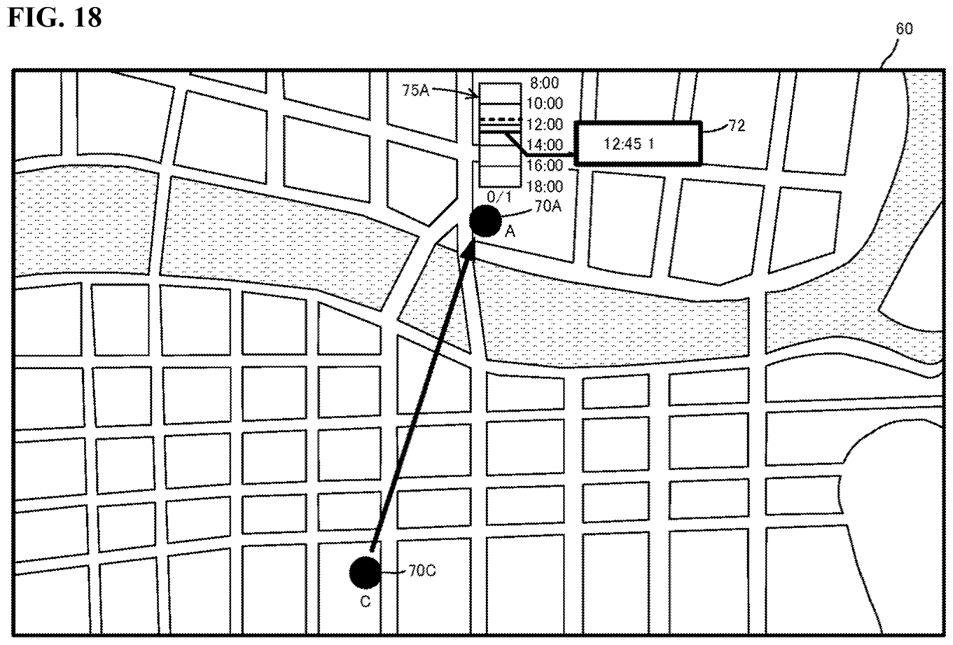

FIG. 18 is a figure showing an example of a display displayed on parcel owner terminal 2 of the sender. FIG. 18 shows a display displayed on parcel owner terminal 2 of the sender C instead of the display shown in FIG. 6.

In timetable 75A, a bold line is shown at the position of 12:45, which is the scheduled arrival time at point A for delivery of the parcel from sender C.

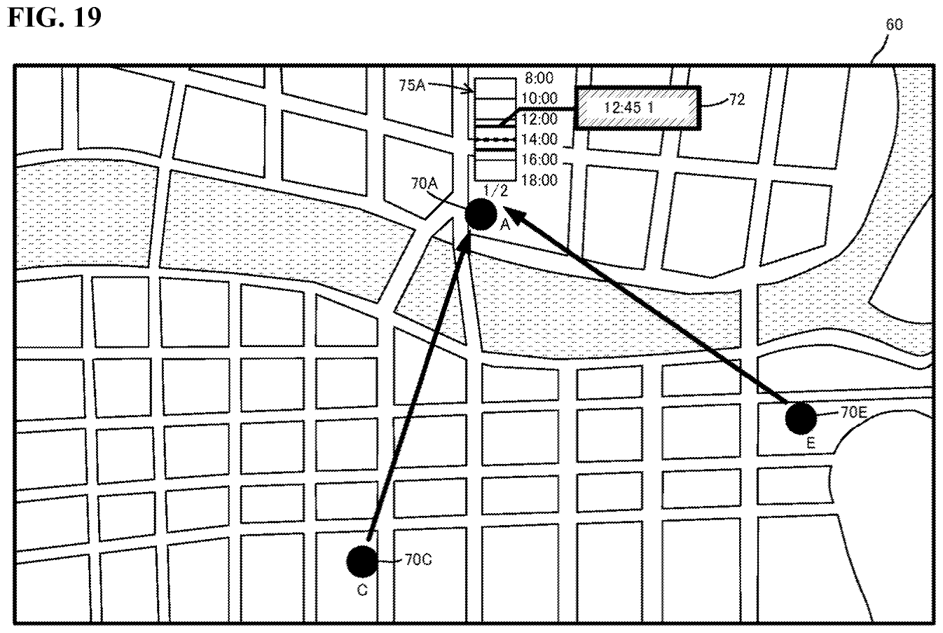

FIG. 19 is a figure showing an example of a display displayed on parcel owner terminal 2 of the recipient. FIG. 19 shows a display displayed on parcel owner terminal 2 of the recipient A instead of the display shown in FIG. 7.

In timetable 75A, the bold line is shown at the positions of 12:45 and 15:00. These times indicate the scheduled arrival time at point A for delivery of the parcel to recipient A.

According to the third embodiment, the user can know the scheduled arrival time and the number of scheduled visits of each point by viewing timetable 75. Further, the number of visits completed is displayed in association with timetable 75, and thus the user can know the number of visits completed of each point.

### APPENDIX

Although traveling management system 1 according to the embodiment of the present disclosure has been described above, the present disclosure is not limited to this embodiment.

Traveling management system 1 described above is used for physical distribution for transporting a parcel, but traveling management system 1 may be used for ride sharing for transporting a plurality of persons by one vehicle 7 or for transporting a person such as a demand-type public transportation. In this case, the article corresponds to a person, and the point corresponds to a boarding place or a getting-off place of a person.

Some or all of the configuration elements configuring traveling management device 4 may be configured from semiconductor device such as one or a plurality of system LSI devices.

Computer program 54 may be recorded in a computer-readable non-transitory recording medium, for example, an HDD, a CD-ROM, or a semiconductor memory, and distributed. The computer program may be distributed by being transmitted via, for example, an electric transmission line, a wireless or wired transmission line, a network represented by the Internet, or data broadcasting.

Traveling management device 4 may be implemented by a plurality of computers or a plurality of processors.

Some or all of the functions of traveling management device 4 may be provided by cloud computing.

At least a part of the embodiments and the modifications may be arbitrarily combined.

The embodiments disclosed herein are to be considered in all respects as illustrative and not restrictive. The scope of the present disclosure is defined by the appended claims rather than the foregoing description, and is intended to include all modifications within the scope and meaning equivalent to the claims.

### REFERENCE SIGNS LIST

1 traveling management system
2 parcel owner terminal
4 traveling management device
5 manager terminal
6 driver terminal
7 vehicle
8 network
40 communication I/F unit
41 input/output I/F unit
42 memory
43 processor
44 bus
51 map information
52 traveling plan information
53 traveling record information
54 computer program
55 traveling plan information acquiring unit
56 probe information acquiring unit
57 traveling record information generating unit (traveling record information acquiring unit)
58 display data generating unit
60 map
70, 70A, 70B, 70C, 70D, 70E circle
71, 71A, 71B, 71C, 71D, 71E figure set
72 visit record data
73 73A 73B 73C 73D 73E icon
74, 74A, 74B, 74C, 74D, 74E icon
75, 75A, 75B, 75C, 75D, 75E timetable

1. A traveling management device comprising:
a traveling plan information acquiring processor configured to acquire traveling plan information indicating a traveling plan of a vehicle to a plurality of points; and
a display data generating processor configured to generate display data to be used for display on a display device, wherein
the display data includes a superimposing information set to be superimposed, based on the traveling plan information, at positions corresponding to the respective points on a map, and
the superimposing information set includes information having a display form by which it is possible to identify a point for which a number of scheduled visits of the vehicle is one and a point for which the number of scheduled visits of the vehicle is plural.

2. The traveling management device according to claim 1, further comprising:
a traveling record information acquiring processor configured to acquire traveling record information indicating a traveling record of the vehicle to the plurality of points, wherein
the display data generating processor is configured to add, based on the traveling record information, visit records at the respective points to the display data.

3. The traveling management device according to claim 1, wherein the superimposing information set includes a figure set in which figures, a number of which corresponds to the number of scheduled visits, are arranged.

4. The traveling management device according to claim 2, wherein
the superimposing information set includes a figure set in which figures, a number of which corresponds to the number of scheduled visits, are arranged, and
the display data generating processor is configured to update the display data by varying, based on a number of visits completed, a display form of the figures included in the figure set for each of the points.

5. The traveling management device according to claim 2, wherein the superimposing information set includes a figure set in which figures, a number of which corresponds to a number of visits not made yet out of the number of scheduled visits, are arranged.

6. The traveling management device according to claim 4, wherein
the traveling plan information includes a scheduled arrival time of the vehicle at each of the points, and
the display data generating processor is configured to add, to the display data, the scheduled arrival time at each of the points corresponding to the figure set, in association with the figure set.

7. The traveling management device according to claim 1, wherein the superimposing information set includes a figure indicating the number of scheduled visits.

8. The traveling management device according to claim 1, wherein the superimposing information set includes a figure having a display form corresponding to the number of scheduled visits.

9. The traveling management device according to claim 7, wherein
the traveling plan information includes a scheduled arrival time of the vehicle at each of the points, and
the display data generating processor is configured to add, to the display data, the scheduled arrival time at each of the points corresponding to the figure, in association with the figure.

10. The traveling management device according to claim 1, wherein
the traveling plan information includes a scheduled arrival time of the vehicle at each of the points, and
the superimposing information set includes a figure indicating the scheduled arrival time in association with a time axis.

11. The traveling management device according to claim 2, wherein
the traveling plan information includes a scheduled arrival time of the vehicle at each of the points,
the superimposing information set includes a figure indicating the scheduled arrival time in association with a time axis, and
the display data generating processor is configured to add, for each of the points, to the display data, a number of visits completed of the vehicle at the point in association with the superimposing information set.

12. The traveling management device according to claim 1, wherein the display data to be used for display on the display device used by a parcel owner of a parcel conveyed in the vehicle includes the superimposing information set having a display form corresponding to a number of scheduled visits at a point of a destination of the parcel relating to the parcel owner.

13. A traveling management method comprising:
acquiring traveling plan information indicating a traveling plan of a vehicle to a plurality of points; and
generating display data to be used for display on a display device, wherein
the display data includes a superimposing information set to be superimposed, based on the traveling plan information, at positions corresponding to the respective points on a map, and
the superimposing information set includes information having a display form by which it is possible to identify a point for which a number of scheduled visits of the vehicle is one and a point for which the number of scheduled visits of the vehicle is plural.

14. A recording medium with a computer program recorded therein for causing a computer to function as:
a traveling plan information acquiring processor configured to acquire traveling plan information indicating a traveling plan of a vehicle to a plurality of points; and
a display data generating processor configured to generate display data to be used for display on a display device, wherein
the display data includes a superimposing information set to be superimposed, based on the traveling plan information, at positions corresponding to the respective points on a map, and
the superimposing information set includes information having a display form by which it is possible to identify a point for which a number of scheduled visits of the vehicle is one and a point for which the number of scheduled visits of the vehicle is plural.
